(19) United States
(12) Patent Application Publication
(10) Pub. No.: US 2016/0045968 A1
(43) Pub. Date: Feb. 18, 2016

(54) APPARATUS FOR ELECTROCHEMICALLY MACHINING A METALLIC WORKPIECE

(71) Applicant: EMAG Holding GmbH, Salach (DE)

(72) Inventors: Richard KELLER, Heilbronn (DE); Walter Thomas GMELIN, Boeblingen (DE)

(21) Appl. No.: 14/826,267

(22) Filed: Aug. 14, 2015

(30) Foreign Application Priority Data
Aug. 16, 2014 (DE) 102014012180.1

(51) Int. Cl. B23H 7/26; B23H 9/14; B23H 3/00

(52) U.S. Cl. CPC B23H 7/26; B23H 3/00; B23H 9/14

(57) ABSTRACT

An apparatus for electrochemically machining a workpiece has a tool having a surface-machining part and a piercing part. The parts are relatively fixed and jointly movable. A power source oppositely polarizes the tool and the workpiece and an electrolyte is fed to the workpiece. The tool is pressed against the workpiece such that the surface-machining part forms a shaped surface on the workpiece and simultaneously the piercing part forms or enlarges a bore in the workpiece.

### FIELD OF THE INVENTION

The present invention relates to electrochemical machining. More particularly this invention concerns an apparatus for simultaneously electrochemically machining a surface of a workpiece while electrochemically boring a hole in the workpiece.

### BACKGROUND OF THE INVENTION

An apparatus for electrochemical machining of metal workpieces typically comprises a tool connected as a cathode to one side of a direct-voltage power supply whose other side is connected to an oversize workpiece being machined. The tool is pushed against or through the workpiece as a liquid electrochemical machining (ECM or PECM) electrolyte is applied to the interface between the tool and the workpiece such that the workpiece is eroded chemically. The result is typically a very precisely shaped workpiece.

As described in U.S. Pat. No. 8,801,906 the external shape of the workpiece corresponds to the external shape of rotor blades to be machined. The electrode is hydraulically moved for more precise production of the external shape. In addition to the external machining, precise microbores can be produced by electrochemical machining. To this end a potential is built up between the component serving as anode and the electrode serving as cathode and the material of the component is removed by an electrolyte.

The electrolyte is passed through the electrode or fed laterally from the electrode onto the region of the component to be machined. Such an electrode is disclosed in DE 10 2010 032. This electrode has an effective area for defining a working gap between a side wall to be removed and the electrode. In this case the effective area is set at an angle obliquely or has an arcuate form.

### OBJECTS OF THE INVENTION

It is therefore an object of the present invention to provide an improved apparatus for electrochemically machining a metallic workpiece.

Another object is the provision of such an improved apparatus for electrochemically machining a metallic workpiece that overcomes the above-given disadvantages, in particular that simultaneously machines a surface and forms a bore in the workpiece.

### SUMMARY OF THE INVENTION

An apparatus for electrochemically machining a workpiece has according to the invention a tool having a surface-machining part and a piercing part. The parts are relatively fixed and jointly movable. A power source oppositely polarizes the tool and the workpiece and an electrolyte is fed to the workpiece. The tool is pressed against the workpiece such that the surface-machining part forms a shaped surface on the workpiece and simultaneously the piercing part forms or enlarges a bore in the workpiece.

Thus according to the invention a single tool is used to both shape an external surface of the workpiece and pierce a hole in it. Performing these two operations at once represents a significant saving in time.

The parts according to the invention move in a straight line when engaged with the workpiece, parallel to an axis of the bore being formed.

When the workpiece is formed with a pilot bore, the piercing part enlarges the pilot bore. Otherwise according to the invention he piercing part has a small-diameter outer part and a larger-diameter inner part so that, when pressed against the workpiece, the outer part forms a pilot bore in the workpiece and then the inner part engages the workpiece and enlarges the pilot bore to a finished diameter

### BRIEF DESCRIPTION OF THE DRAWING

The above and other objects, features, and advantages will become more readily apparent from the following description, reference being made to the accompanying drawing in which:

FIG. 1 is a partly schematic view of a first ECM system according to the invention at the very start of a machining operation;

FIG. 2 is a view like FIG. 1 showing the first ECM system at the end of the machining operation;

FIGS. 3a and 3b are plan and side views of another ECM tool according to the invention taken in mutually perpendicular directions;

FIGS. 4a, 4b, and 4c are sectional views illustrating the steps of a machining operation with the tool of FIGS. 3a and 3b;

FIG. 5a is a top view of the workpiece machined according to FIGS. 4a-c; and

FIG. 5b is a side partly sectional view of the finished workpiece of FIG. 5a.

### SPECIFIC DESCRIPTION OF THE INVENTION

FIG. 1 shows a workpiece 3, here a cam disk with a central bore 7, fitted to a workpiece holder 5. The workpiece 3 is fixed correctly in position by a centering pin 4 fitting into the bore 7. The centering pin 4 is biased by a spring 15 and can be moved out of the bore 7 against the spring force.

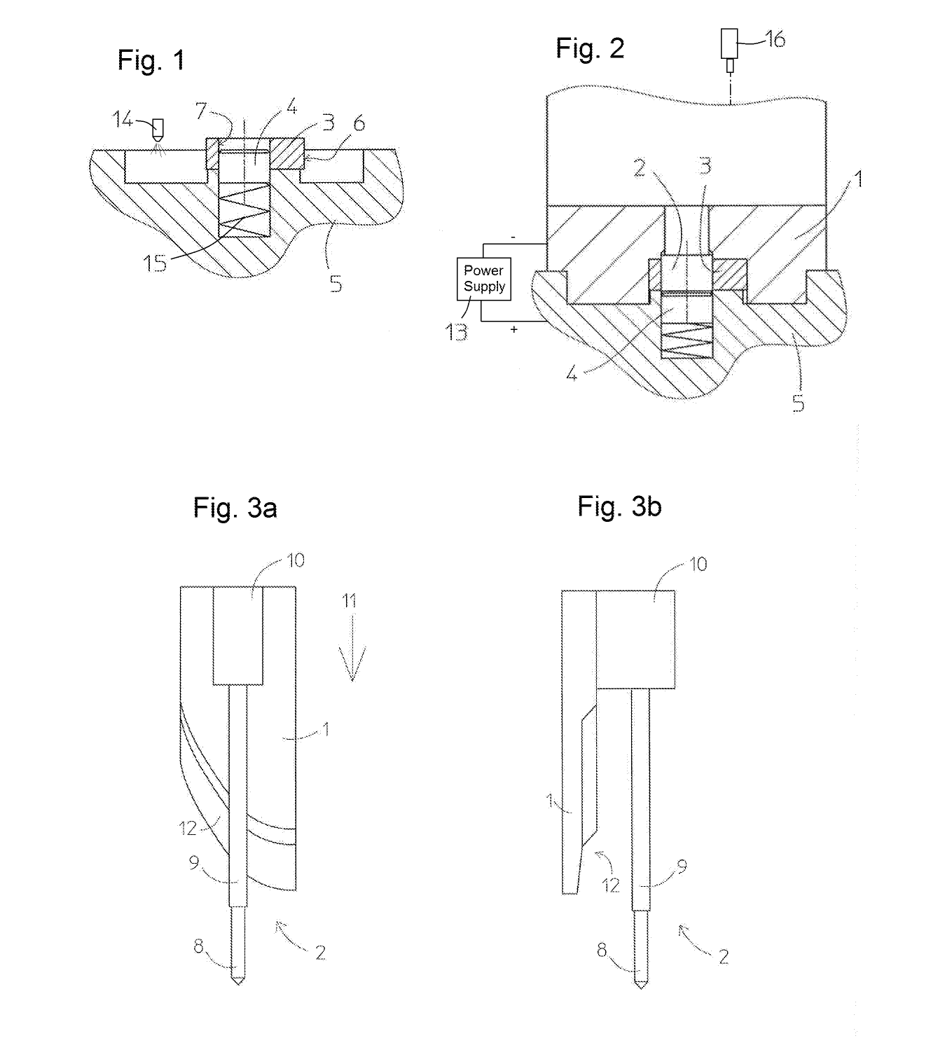

FIG. 2 shows the apparatus during machining. The electrode part 1 for machining the workpiece surface 6 and the electrode part 2 for machining the workpiece cutout 7 have been lowered together onto the workpiece 3. A power supply 13 (FIG. 1 only) is connected between the holder 5 of the workpiece 3 and the tool 1. An actuator shown schematically at 16 (FIG. 2 only) pushes the tool 1 down coaxially with the bore 7 so that the hole-machining part 2 pushes the centering pin 4. Meanwhile an is electrolyte is supplied from a nozzle shown schematically in 14 (FIG. 1 only). In the preformed bore 7 a machining allowance is removed and/or a profile is produced by removal of material. Advantageously the bore 7 in the cam disk 3 and the external cam shape are electrochemically machined simultaneously while the workpiece is in the holder 5. Thus in addition to shortening of cycle time, extremely precise machining of workpieces is possible.

FIGS. 3a and 3b show the electrode parts 1 and 2 both carried on an electrode holder 10. The electrode part 1 has a profile 12 complementary to a workpiece surface 6 to be formed.

The electrode part 2 for producing microbores is divided into two regions. In the feed direction 11 a pilot segment 8 penetrates into the workpiece and produces a bore that is subsequently enlarged to the finished dimension by the calibrating segment 9.

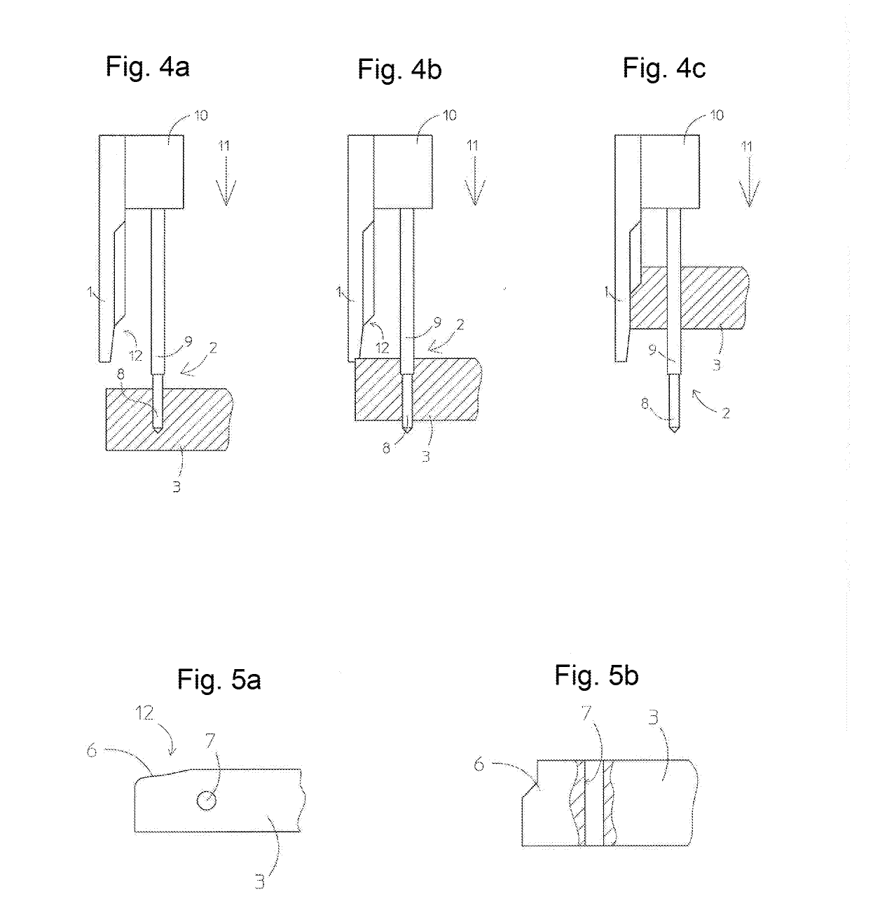

Engagement of the electrodes into the workpiece is explained in greater detail in FIGS. 4a to 4c. FIG. 4a shows the production of a bore by the pilot segment 8. As the electrode part 2 penetrates further into the workpiece 3 the calibrating segment 9 also comes into engagement and widens the bore to the finished diameter. Finally, FIG. 4c shows the completion of the bore and the machining of the workpiece surface 6 by the electrode part 1. In this case a profile 12 is produced on the workpiece surface 6. Particularly advantageously, with one single feeding movement not only is a workpiece bore 7 formed but a profile 12 is also formed on the workpiece surface 6. For better understanding the machined part of the workpiece 3 is shown separately in FIGS. 5a and 5b.

We claim:

1. An apparatus for electrochemically machining a workpiece, the apparatus comprising:
a tool having a surface-machining part and a piercing part, the parts being relatively fixed and jointly movable;
means for oppositely polarizing the tool and the workpiece and for feeding an electrolyte to the workpiece; and
means for pressing the tool against the workpiece such that the surface-machining part forms a shaped surface on the workpiece and simultaneously the piercing part forms or enlarges a bore in the workpiece.

2. The ECM apparatus defined in claim 1, wherein the parts move in a straight line when engaged with the workpiece.

3. The ECM apparatus defined in claim 1, wherein the workpiece is formed with a pilot bore and the piercing part enlarges the pilot bore.

4. The ECM apparatus defined in claim 1, wherein the piercing part has a small-diameter outer part and a larger-diameter inner part.

5. The ECM apparatus defined in claim 4, wherein when pressed against the workpiece, the outer part forms a pilot bore in the workpiece.

6. The ECM apparatus defined in claim 5, wherein when the inner part engages the workpiece it enlarges the pilot bore to a finished diameter.
